(19) United States
(12) Patent Application Publication
(10) Pub. No.: US 2015/0062063 A1
(43) Pub. Date: Mar. 5, 2015

(54) METHOD OF RECOGNIZING TOUCH

(71) Applicant: TIANJIN FUNAYUANCHUANG TECHNOLOGY CO.,LTD., Tianjin (CN)

(72) Inventors: CHIEN-YUNG CHENG, New Taipei (TW); CHENG-TAI HUANG, New Taipei (TW); PO-SHENG SHIH, New Taipei (TW)

(73) Assignee: TIANJIN FUNAYUANCHUANG TECHNOLOGY CO.,LTD., Tianjin (CN)

(21) Appl. No.: 14/149,814

(22) Filed: Jan. 8, 2014

(30) Foreign Application Priority Data
Aug. 29, 2013 (CN) 2013103838815

(51) Int. Cl. G06F 3/044

(52) U.S. Cl. CPC G06F 3/044
USPC 345/174

(57) ABSTRACT

A method for recognizing touch on a touch panel is provided. A value T₀ is set. First set of sensing and driving electrode pairs are driven and sensed and second set of sensing and driving electrode pairs are driven simultaneously. A number of first signal values C₁ are obtained. C₁ is compared with T₀. When C₁ is smaller than the T₀, no touch is recognized. When C₁ is greater than or equal to T₀, following steps are taken. The first set of sensing and driving electrode pairs are driven and sensed and the second set of sensing and driving electrode pairs are connected to ground simultaneously. A number of second signal values C₂ are obtained. C₁ is compared with C₂. When C₂ is smaller than or equal to C₁, a grounded object touch is recognized. When C₂ is greater than C₁, a water touch is recognized.

This application claims all benefits accruing under 35 U.S.C. §119 from China Patent Application No. 201310383881.5, filed on Aug. 29, 2013 in the China Intellectual Property Office, the contents of which are hereby incorporated by reference.

### BACKGROUND

1. Technical Field

The present disclosure relates to methods for recognizing touch on a touch panel and, particularly, a method of recognizing touch on a capacitive touch panel.

2. Description of Related Art

In recent years, various electronic apparatuses such as mobile phones, car navigation systems have advanced toward high performance and diversification. There is continuous growth in the number of electronic apparatuses equipped with optically transparent touch panels in front of their display devices such as liquid crystal panels. A user of such electronic apparatus operates it by pressing a touch panel with a grounded object, e.g. a finger or a stylus, while visually observing the display device through the touch panel.

According to working principle and transmission medium, touch panel has four types of resistance, capacitance, infra-red, and surface acoustic-wave. Capacitive touch panel has been widely used for higher sensitivity and less touch pressure required.

Working principle of capacitive touch panel is as follows: distribution of capacitances on the touch panel is changed by grounded object touch, the change of distribution of capacitances is detected and a touch position is obtained. However, if water is present on the touch panel, it would lead to change of capacitance and be recognized as a grounded object touch by mistake, thereby causing inconvenience to users.

What is needed, therefore, is a method of recognizing touch that can overcome the above-described shortcomings.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a flowchart of a method of recognizing touch on a touch panel.

FIG. 2 is a view of signals of a touch screen having water detected by two different driving and sensing methods.

FIG. 3 is a view of signals of a touch screen of grounded object touching detected by two different driving and sensing methods.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

The first embodiment of the method of recognizing touch is provided. The method of recognizing touch can be applied on all kinds of self-inductance capacitive touch panels. In the self-inductance capacitive touch panels, changes of capacitance between conductive film of the touch panels and ground are detected in the capacitive touch panels.

The self-inductance capacitive touch panel comprises a transparent insulative substrate, a transparent conductive film, a plurality of pairs of sensing and driving electrodes, and a plurality of integrated circuits (ICs). The transparent conductive film is located on a surface of the transparent insulative substrate. The plurality of pairs of sensing and driving electrodes are electrically connected with the transparent conductive film. Each of the plurality of pairs of sensing and driving electrode comprises a first electrode and a second electrode. The second electrode is spaced from and opposite to the first electrode. The plurality of ICs are electrically connected with each of the plurality of pairs of sensing and driving electrodes. The transparent conductive film is driven and sensed by the first electrode and the second electrode alternately. For example, when the transparent conductive film is driven by the first electrode, a first capacitance is sensed by the second electrode; and when the transparent conductive film is driven by the second electrode, a second capacitance is sensed by the first electrode. Changes of a plurality of capacitances of the transparent conductive films are detected by the plurality of ICs.

The transparent conductive film can be a conductive film with anisotropic impedance. A surface of the transparent conductive film has a high impedance along a first direction. The surface of the transparent conductive film has a low impedance along a second direction. The plurality of sensing and driving electrodes are located on at least one side of the transparent conductive film along the first direction and spaced with each other. In one embodiment, the transparent conductive film comprises a plurality of conductive blocks. The plurality of conductive blocks are spaced from each other and arranged in an array. Shape of one of the plurality of conductive blocks can be rectangle, rhombus, and so on. Material of the plurality of conductive blocks can be indium tin oxide (ITO) or carbon nanotube. Each of the plurality of conductive blocks is electrically connected with one of the plurality of ICs via one of the plurality of pairs of sensing and driving electrodes.

Each of the plurality of ICs comprises a driving IC and a sensing IC. The driving IC is used to provide driving signals to the plurality of pairs of sensing and driving electrodes. The sensing IC is used to detect signal values via the plurality of pairs of sensing and driving electrodes.

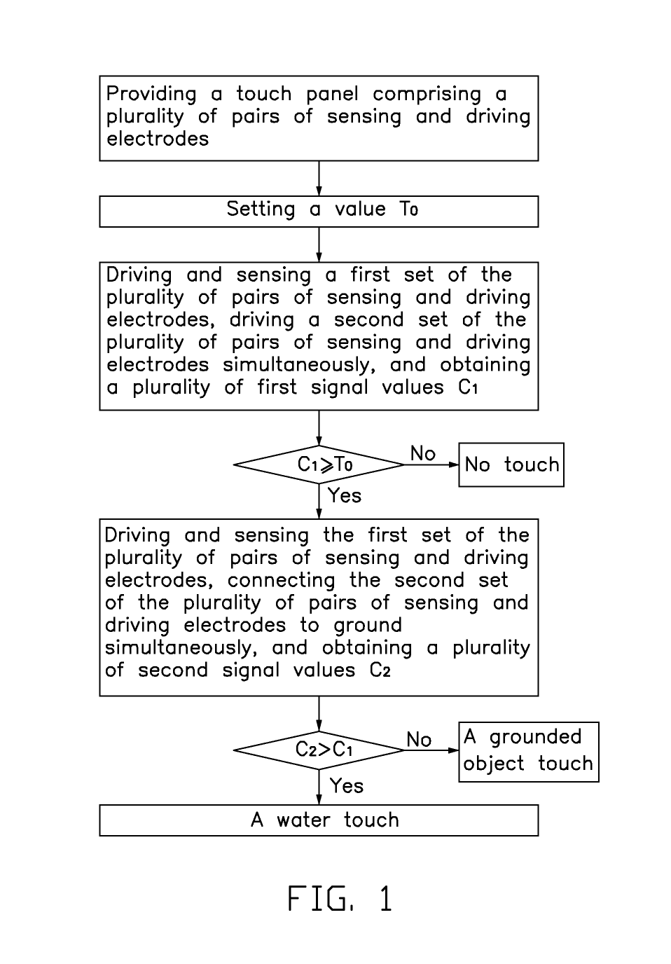

Referring to FIG. 1, the method of recognizing touch comprises following steps:

S1, setting a value T₀;

S2, driving and sensing first set of the plurality of pairs of sensing and driving electrodes, driving second set of the plurality of pairs of sensing and driving electrodes simultaneously, and obtaining a plurality of first signal values C₁;

S3, comparing the plurality of first signal values C₁ with the value T₀, when the plurality of first signal values C₁ is smaller than the value T₀, recognizing as no touch; when the plurality of first signal values C₁ is greater than or equal to the value T₀, taking following steps;

S4, driving and sensing the first set of the plurality of pairs of sensing and driving electrodes, connecting the second set of the plurality of pairs of sensing and driving electrodes to ground simultaneously, and obtaining a plurality of second signal values C₂; and

S5, comparing the plurality of first signal values C₁ with the plurality of second signal values C₂, when the plurality of second signal values C₂ are smaller than or equal to the plurality of first signal values C₁, recognizing as grounded object touch; when the plurality of second signal values C₂ are greater than the plurality of first signal values C₁, recognizing as a water touch.

In step (S1), the value T₀ can be a threshold of sensing signal of traditional capacitive touch panel. In one embodiment, the value T₀ is defined as a maximum signal value of sensing when a grounded object, e.g. a finger and stylus, contacts the touch panel in a critical state. The critical state means that distance between the grounded object and a screen of the touch panel is very small and the grounded object nearly contacts the screen.

In step (S2), the plurality of first signal values C₁ is a difference value between signal values at one position of the transparent conductive film when the touch panel is touched and not touched.

The plurality of first signal values C₁ are obtained by a first driving and sensing method. In the first driving and sensing method, some neighboring electrodes of the plurality of pairs of driving and sensing electrodes can be driven and sensed simultaneously, or one of the plurality of pairs of driving and sensing electrodes can be driven and sensed each time. In one embodiment, one of the plurality of pairs of driving and sensing electrodes is driven each time, that is, the first electrode and the second electrode are driven and sensed alternately, and other of plurality of pairs of driving and sensing electrodes are driven at the same time. The plurality of first signal values C₁ are difference value between signal values at one position of the transparent conductive film when the touch panel is touched and not touched.

In step (S3), when all of the plurality of first signal values C₁ are smaller than the value T₀, it is determined that the touch panel is not touched. When one of the plurality of first signal values C₁ is greater than or equal to the value T₀, it is further determined whether it is the touched by water by the steps (S4) and (S5).

In steps (S4) and (S5), the plurality of second signal values C₂ are obtained by a second driving and sensing method. In one embodiment, the first electrode and the second electrode of one of plurality of pairs of driving and sensing electrodes are driven and sensed alternately, and other of plurality of pairs of driving and sensing electrodes are connected to the ground at the same time. Driving signals of the first driving and sensing method is same as that of the second driving and sensing method. The plurality of second signal values C₂ are difference value between signal values at one position of the transparent conductive film when the touch panel is touched and not touched.

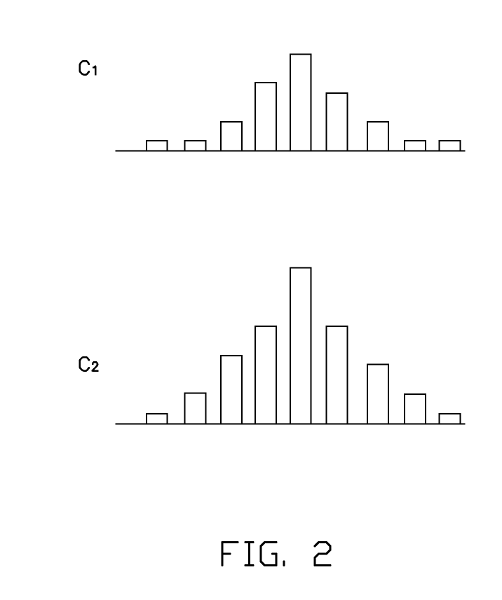

Referring to FIG. 2, when the touch panel is touched with water, the plurality of pairs of driving and sensing electrodes are driven by the first driving and sensing method to obtain the plurality of first signal values C₁ first, and then driven by the second driving and sensing method to obtain the plurality of second signal values C₂. Because the water is electrically conductive, part of signals are contributed by neighboring electrodes when the neighboring electrodes are connected to the ground in the second driving and sensing method. Thus, the plurality of second signal values C₂ are greater than the plurality of first signal values C₁ at the same pair of driving and sensing electrodes.

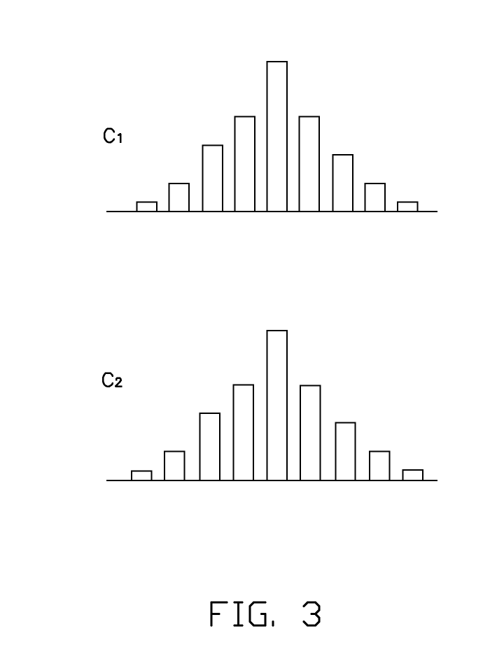

Referring to FIG. 3, when the touch panel is touched with grounded object, the plurality of pairs of driving and sensing electrodes are driven by the first driving and sensing method to obtain the plurality of first signal values C₁ first, and then driven by the second driving and sensing method to obtain the plurality of second signal values C₂. Because the grounded object is grounded itself, the plurality of second signal values C₂ are substantially the same as the plurality of second signal values C₁ at the same driving and sensing electrodes. Therefore, the water touch and the grounded object touch can be distinguished by comparing one of the plurality of second signal values C₂ with corresponding one of the plurality of second signal values C₁ at same pair of driving and sensing electrode.

When the touch panel is touched with water, if the water of the touch panel is further touched by a grounded object, following steps (S6) and (S7) can be taken to accept the input of the grounded object.

S6, driving and sensing some of the plurality of pairs of sensing and driving electrodes in order, driving other of the plurality of pairs of sensing and driving electrodes simultaneously, and obtaining a plurality of third signal values C₃; and

S7, comparing the plurality of third signal values C₃ with the plurality of second signal values C₂, when the plurality of third signal values C₃ are smaller than or equal to the plurality of second signal values C₂, recognizing as a water touch; when the plurality of third signal values C₃ are greater than the plurality of second signal values C₂, recognizing as a water and grounded object touch and then correcting the plurality of third signal values C₃.

The plurality of third signal values C₃ are obtained by the first driving and sensing method. The plurality of third signal values C₃ are difference value between signal values at one position of the transparent conductive film when the touch panel is touched and not touched. When the grounded object touches the water on the touch panel, the water would be connected to the ground via the grounded object and the signals would be distributed, whereby the plurality of third signal values C₃ are greater than signal values of the touch panel only touched with grounded object. The plurality of third signal values C₃ are corrected by subtracting the plurality of second signal values C₂ at the same driving and sensing electrode. Then touch position is calculated according to the plurality of corrected C₃.

The second embodiment of the method of recognizing touch is provided. The method is similar to that of the first embodiment, except that, the transparent conductive film comprises a carbon nanotube structure. The carbon nanotube structure is a conductive film with anisotropic impedance and a successive complete structure. A surface of the carbon nanotube structure has a high impedance along a first direction. The surface of the carbon nanotube structure has a low impedance along a second direction. The plurality of sensing and driving electrodes are spaced with each other. The plurality of sensing and driving electrodes are arranged on at least one side of the carbon nanotube structure along the first direction. The carbon nanotube structure comprises at least one carbon nanotube film. The carbon nanotube film can be obtained by drawing from a carbon nanotube array. The carbon nanotube film comprises a plurality of successive and oriented carbon nanotubes joined end-to-end by van der Waals attractive force therebetween. A majority of the plurality of carbon nanotubes are arranged to extend along the second direction. The plurality of carbon nanotubes are parallel with a surface of the carbon nanotube film.

Both grounded object touch and water touch are recognized via this method. Signal values can be corrected when the touch panel is touched by water and grounded object.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure.

What is claimed is:

1. A method of recognizing touch, the method comprising:
providing a touch panel comprising a plurality of pairs of sensing and driving electrodes,
setting a value T₀;
driving and sensing a first set of the plurality of pairs of sensing and driving electrodes, driving a second set of the plurality of pairs of sensing and driving electrodes simultaneously, and obtaining a plurality of first signal values C₁;
comparing the plurality of first signal values C₁ with the value T₀, when the plurality of first signal values C₁ is smaller than the value T₀, recognizing as no touch; and when the plurality of first signal values C₁ is greater than or equal to the value T₀, further taking following steps (a) and (b);
step (a), driving and sensing the first set of the plurality of pairs of sensing and driving electrodes, connecting the second set of the plurality of pairs of sensing and driving electrodes to ground simultaneously, and obtaining a plurality of second signal values C₂; and
step (b), comparing the plurality of first signal values C₁ with the plurality of second signal values C₂, when the plurality of second signal values C₂ are smaller than or equal to the plurality of first signal values C₁, recognizing to a grounded object touch; when the plurality of second signal values C₂ are greater than the plurality of first signal values C₁, recognizing to a water touch.

2. The method of claim 1, wherein the value T₀ is defined as a maximum signal value of sensing when a grounded object contacts the touch panel in a critical state.

3. The method of claim 1, wherein the driving and sensing the first set of the plurality of pairs of sensing and driving electrodes comprises driving the first set of neighboring electrodes of the plurality of pairs of driving and sensing electrodes simultaneously.

4. The method of claim 1, wherein each of the plurality of pairs of driving and sensing electrodes comprises a first electrode and a second electrode, and the driving and sensing the first set of the plurality of pairs of sensing and driving electrodes comprises driving the first electrode and the second electrode alternately.

5. The method of claim 1, wherein the plurality of first signal values C₁ and the plurality of second signal values C₂ are difference values between signal values of the touch panel when the touch panel is touched and not touched.

6. The method of claim 1, wherein when one of the plurality of first signal values C₁ is greater than or equal to the value T₀, it is further determined whether the touch is the water touch.

7. The method of claim 1, wherein the comparing the plurality of first signal values C₁ with the plurality of second signal values C₂ comprises: comparing the plurality of second signal values C₂ with the plurality of first signal values C₁ at a same pair of driving and sensing electrode, when one of the plurality of second signal values C₂ is greater than corresponding one of the plurality of first signal values C₁, recognizing as the water touch.

8. The method of claim 1, wherein when the plurality of second signal values C₂ are greater than the plurality of first signal values C₁, the method further comprises following sub-steps:
driving and sensing the some of the plurality of pairs of sensing and driving electrodes in order, driving the other of the plurality of pairs of sensing and driving electrodes simultaneously, and obtaining a plurality of third signal values C₃; and
comparing the plurality of third signal values C₃ with the plurality of second signal values C₂, when the plurality of third signal values C₃ are smaller than or equal to the plurality of second signal values C₂, recognizing as the water touch; and when the plurality of third signal values C₃ are greater than the plurality of second signal values C₂, recognizing as a water and grounded object touch, and then correcting the plurality of third signal values C₃.

9. The method of claim 8, wherein further comprising correcting the plurality of third signal values C₃ by subtracting the plurality of second signal values C₂ at a same pair of driving and sensing electrode.
